(19) United States
(12) Patent Application Publication
(10) Pub. No.: US 2025/0308447 A1
(43) Pub. Date: Oct. 2, 2025

(54) DISPLAY DEVICE AND DISPLAY DEVICE DRIVING METHOD

(71) Applicant: SAMSUNG DISPLAY CO., LTD., YONGIN-SI (KR)

(72) Inventors: DAEHO HWANG, Yongin-si (KR); TAEWAN KIM, Yongin-si (KR); HWAAN SUNG, Yongin-si (KR); CHUL SHIN, Yongin-si (KR); JIYOUNG EOM, Yongin-si (KR); JEONGAH LEE, Yongin-si (KR)

(21) Appl. No.: 18/973,040

(22) Filed: Dec. 8, 2024

(30) Foreign Application Priority Data
Mar. 26, 2024 (KR) 10-2024-0041098

(51) Int. Cl. G09G 3/3233; G01K 3/00; G01K 3/02; G01K 7/00; G09G 3/32

(52) U.S. Cl. CPC G09G 3/3233; G01K 3/005; G01K 3/02; G01K 7/00; G09G 3/32; G09G 2300/0819; G09G 2300/0842; G09G 2320/041; G09G 2330/02; G09G 2330/045; G09G 2330/12

(57) ABSTRACT

A display device including: a display panel including a plurality of pixels; a voltage generator configured to provide a driving voltage to the plurality of pixels; and a driving controller configured to receive an image signal and drive the plurality of pixels in frame units, wherein the driving controller includes: a power control circuit configured to receive image data generated based on the image signal and output a load of the image data; a temperature prediction circuit configured to calculate a temperature value of the display panel; a memory configured to store a load-specific temperature lookup table; and a protection determination circuit configured to block an operation of the voltage generator when the temperature value exceeds a threshold value for a predetermined time, based on the load, the load-specific temperature lookup table, and the temperature value.

### CROSS-REFERENCE TO RELATED APPLICATION

This application claims priority under 35 U.S.C. § 119 to Korean Patent Application No. 10-2024-0041098 filed on Mar. 26, 2024, in the Korean Intellectual Property Office, the disclosure of which is incorporated by reference herein in its entirety.

### TECHNICAL FIELD

Embodiments of the present disclosure relate to a display device with improved reliability and a method for driving the display device.

### DISCUSSION OF RELATED ART

Various display devices are being developed for use in multi-media devices such as televisions, mobile phones, tablet computers, navigation systems, and game consoles.

As the applications of these display devices diversify, the types of display panels for displaying images are also becoming more varied.

Currently, display panels include light emitting display panels, which may include organic light emitting display panels or quantum dot light emitting display panels.

### SUMMARY

Embodiments of the present disclosure provide a display device with improved reliability and a method for driving the display device.

According to an embodiment of the present disclosure, there is provided a display device including: a display panel including a plurality of pixels; a voltage generator configured to provide a driving voltage to the plurality of pixels; and a driving controller configured to receive an image signal and drive the plurality of pixels in frame units, wherein the driving controller includes: a power control circuit configured to receive image data generated based on the image signal and output a load of the image data; a temperature prediction circuit configured to calculate a temperature value of the display panel; a memory configured to store a load-specific temperature lookup table; and a protection determination circuit configured to block an operation of the voltage generator when the temperature value exceeds a threshold value for a predetermined time, based on the load, the load-specific temperature lookup table, and the temperature value.

The predetermined time is a count value obtained by counting a number of the frames, and when the count value exceeds a predetermined value, the protection determination circuit determines that the predetermined time has been exceeded.

When the temperature value exceeds the threshold value for the predetermined time, the protection determination circuit generates a temperature protection flag signal.

The protection determination circuit transmits the temperature protection flag signal to the voltage generator.

The power control circuit includes: a load calculation circuit configured to calculate a sum of all grayscales of the image data based on the image data; a load representative value calculation circuit configured to calculate the load of the image data based on the sum; and a scale factor setting circuit configured to generate a scale factor to change a grayscale of the image data based on the load.

Each of the plurality of pixels includes a pixel circuit and a light emitting element, wherein the pixel circuit includes a driving transistor, and wherein the temperature prediction circuit calculates the temperature value based on a threshold voltage of the driving transistor.

The temperature value of the display panel includes an average temperature value and a peak temperature value.

A minimum temperature, an average temperature, and a maximum temperature of the display panel for respective loads are stored in the load-specific temperature lookup table, and wherein the minimum temperature, the average temperature, or the maximum temperature is the threshold value.

The protection determination circuit compares the peak temperature value with the maximum temperature in the load-specific temperature lookup table.

The protection determination circuit further compares the average temperature value of the display panel with the average temperature in the load-specific temperature lookup table.

The protection determination circuit calculates the minimum temperature, the average temperature, and the maximum temperature for the load, which are not included in the load-specific temperature lookup table, using an interpolation method.

The display device further includes a temperature sensor configured to measure temperature information of the display panel.

When the temperature information is different from the temperature value, the protection determination circuit generates a signal that indicates a malfunction of the temperature prediction circuit.

According to an embodiment of the present disclosure, there is provided a method for driving a display device including a display panel including a plurality of pixels, a voltage generator for providing a driving voltage to the plurality of pixels, and a driving controller for driving the plurality of pixels in units of a frame, the method including: outputting a load for image data generated based on an image signal; calculating a temperature value of the display panel; and blocking an operation of the voltage generator when the temperature value exceeds a threshold value for a predetermined time, based on the load, a load-specific temperature lookup table, and the temperature value.

The predetermined time is a count value obtained by counting a number of the frames, and when the count value exceeds a predetermined value, the predetermined time has been exceeded.

The blocking of the operation of the voltage generator includes: when the temperature value exceeds the threshold value for the predetermined time, generating a temperature protection flag signal, and transmitting the temperature protection flag signal to the voltage generator.

Each of the plurality of pixels includes a pixel circuit and a light emitting element, wherein the pixel circuit includes a driving transistor, and wherein the calculating of the temperature value includes: calculating the temperature value based on a threshold voltage of the driving transistor.

The temperature value includes an average temperature value and a peak temperature value, wherein a minimum temperature, an average temperature, and a maximum temperature of the display panel for a respective load are stored in the load-specific temperature lookup table, and wherein the blocking of the operation of the voltage generator includes: comparing the peak temperature value with the maximum temperature in the load-specific temperature lookup table.

The blocking of the operation of the voltage generator further includes: comparing the average temperature value with the average temperature in the load-specific temperature lookup table.

A temperature of the load-specific temperature lookup table is the threshold value, and wherein the blocking of the operation of the voltage generator includes: calculating the temperature for the load, which is not included in the load-specific temperature lookup table, using an interpolation method.

According to an embodiment of the present disclosure, there is provided a display device including: a display panel including a plurality of pixels; a voltage generator configured to provide a driving voltage to the plurality of pixels; and a driving controller configured to receive an image signal and drive the plurality of pixels in frame units, wherein the driving controller includes: a power control circuit configured to determine a load associated with image data in the image signal; a temperature prediction circuit configured to calculate a temperature of the display panel; a memory configured to store temperature data for different loads; and a protection determination circuit configured to stop an operation of the voltage generator when the temperature exceeds a predetermined threshold for a predetermined time, based on the load and the stored temperature data.

### BRIEF DESCRIPTION OF THE DRAWINGS

The above and other features of the present disclosure will become apparent by describing in detail embodiments thereof with reference to the accompanying drawings.

FIG. 1 is a perspective view of a display device, according to an embodiment of the present disclosure.

FIG. 2 is an exploded perspective view of a display device, according to an embodiment of the present disclosure.

FIG. 3 is a block diagram showing a part of a display device, according to an embodiment of the present disclosure.

FIG. 4 is an equivalent circuit diagram of a pixel, according to an embodiment of the present disclosure.

FIG. 5 is a block diagram showing a driving controller, according to an embodiment of the present disclosure.

FIG. 6 is a block diagram of a power control unit, according to an embodiment of the present disclosure.

FIG. 7 is a flowchart illustrating a method of driving a display device, according to an embodiment of the present disclosure.

FIG. 8 shows a load-specific temperature lookup table, according to an embodiment of the present disclosure.

### DETAILED DESCRIPTION OF THE EMBODIMENTS

In the specification, the terms “on”, “connected with”, or “coupled with” regarding a first component (or region, layer, part, portion, etc.) and a second component indicate that the first component is either directly on, connected with, or coupled with the second component, or that a third component is interposed therebetween.

The same reference numerals denote the same components. Additionally, in drawings, the thickness, ratio, and dimension of components may be exaggerated to effectively describe the technical content. The term “and/or” refers to one or more combinations, where each combination is defined by its associated elements.

Although the terms “first”, “second”, etc. may be used to describe various components, the components should not be construed as being limited by these terms. These terms are used to distinguish one component from another component. For example, a first component may be referred to as a second component, and similarly, the second component may be referred to as the first component. The articles “a,” “an,” and “the” are singular in that they refer to a single entity; however, their use in the specification should not preclude the possibility of multiple entities being present.

The terms “under”, “below”, “on”, “above”, etc. are used to describe the correlation of components illustrated in drawings. These relative terms are based on a direction shown in drawings.

It will be understood that the terms “include”, “comprise”, “have”, etc. specify the presence of features, numbers, steps, operations, elements, or components, described in the specification, or a combination thereof. They do not preclude the presence or additional possibility of one or more other features, numbers, steps, operations, elements, or components or a combination thereof.

Unless otherwise defined, all terms (including technical terms and scientific terms) used in the specification have the meanings commonly understood by one skilled in the art to which the present disclosure pertains. Furthermore, terms defined in commonly used dictionaries should be interpreted in a manner consistent with their contextual meaning in the related technology, and should not be interpreted in idealized or overly formal sense, unless explicitly defined otherwise.

Hereinafter, embodiments of the present disclosure will be described with reference to the accompanying drawings.

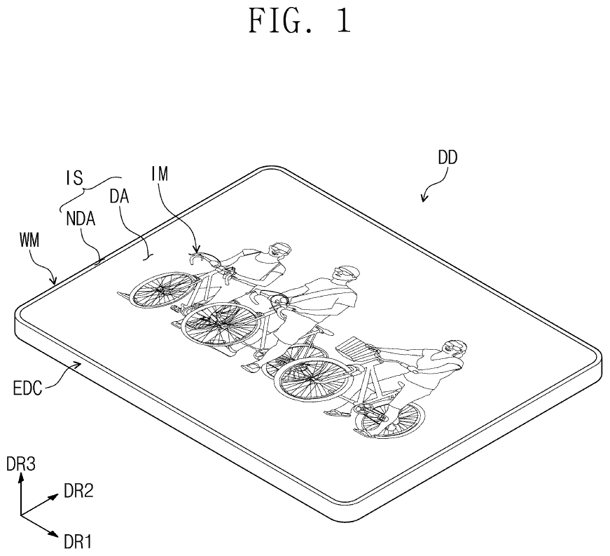

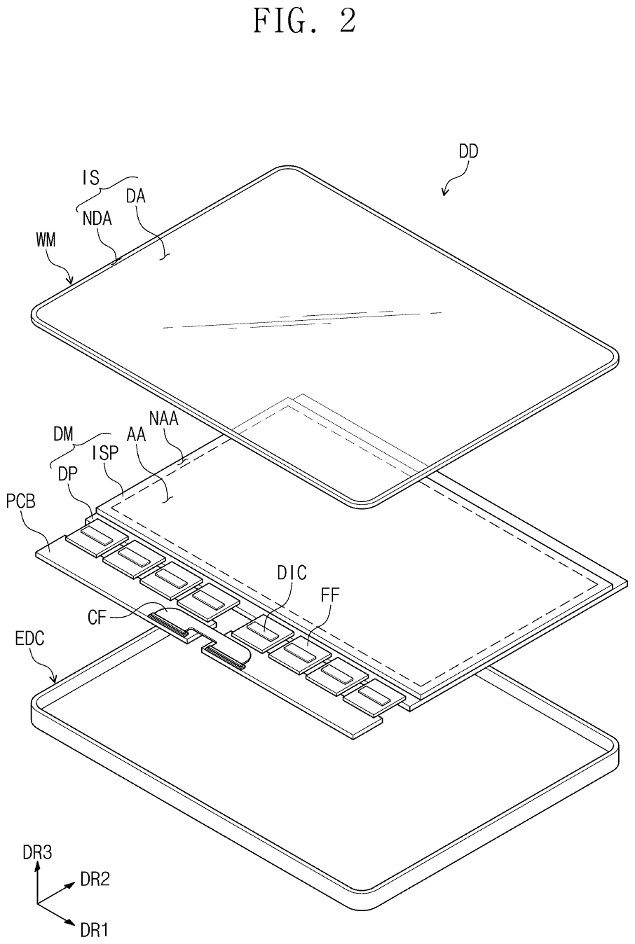

FIG. 1 is a perspective view of a display device, according to an embodiment of the present disclosure. FIG. 2 is an exploded perspective view of a display device, according to an embodiment of the present disclosure.

Referring to FIGS. 1 and 2, a display device DD may be a device that operates based on an electrical signal. The display device DD according to an embodiment of the present disclosure may be a small to medium-sized electronic device, such as a mobile phone, a tablet personal computer (PC), a notebook computer, a vehicle navigation system, or a game console, as well as a large-sized electronic device, such as a television or a monitor. These examples are illustrative only, and it is clear that the display device DD may be implemented in other forms without departing from the scope of the present disclosure.

The display device DD has a rectangular shape with a long side along a first direction DR1 and a short side along a second direction DR2 that intersects the first direction DR1. However, the shape of the display device DD is not limited thereto. For example, the display device DD may be implemented in various other shapes. The display device DD may display an image IM on a display surface IS that is parallel to each of the first direction DR1 and the second direction DR2, and faces a third direction DR3. The display surface IS on which the image IM is displayed may correspond to a front surface of the display device DD.

In an embodiment, a front surface (or an upper/top surface) and a rear surface (or a lower/bottom surface) of each member (or component) are defined based on a direction in which the image IM is displayed. The front surface may be opposite to the rear surface in the third direction DR3, and a normal direction of each of the front surface and the rear surface may be parallel to the third direction DR3.

A distance between the front surface and the rear surface along the third direction DR3 may correspond to a thickness of the display device DD in the third direction DR3. It is noted that the first, second, and third directions DR1, DR2, and DR3 are relative concepts and may correspond to different directions.

The display device DD may sense an external input applied from the outside. In other words, the display device DD may detect external inputs applied from outside. The external input may include various types of inputs that are provided from the outside of the display device DD. The display device DD according to an embodiment of the present disclosure may sense a user's external input, such as a part of his/her body, light, heat, his/her gaze, or pressure, or a combination thereof. Additionally, the display device DD may sense the external input of the user applied to its side or rear surface depending on its structure, and is not limited to any particular embodiment. As an example, an external input may include an input entered through an input device (e.g., a stylus pen, an active pen, a touch pen, an electronic pen, or an E-pen).

The display surface IS of the display device DD may be divided into a display area DA and a non-display area NDA. The display area DA may be an area in which the image IM is displayed. A user perceives (or views) the image IM through the display area DA. In an embodiment, the display area DA is illustrated as a quadrangle with rounded vertices. However, this is merely an example. The display area DA may have various shapes, and is not limited to this specific embodiment.

The non-display area NDA is adjacent to the display area DA. The non-display area NDA may have a given color. The non-display area NDA may surround the display area DA. Accordingly, a shape of the display area DA may be defined substantially by the non-display area NDA. However, this is merely an example. The non-display area NDA may be positioned adjacent to only one side of the display area DA or may be omitted. The display device DD according to an embodiment of the present disclosure may include various configurations and is not limited to a specific embodiment.

The display device DD may include a display module DM and a window WM disposed on the display module DM. The display module DM may include a display panel DP and an input sensing layer ISP.

According to an embodiment of the present disclosure, the display panel DP may include a light emitting display panel. For example, the display panel DP may be an organic light emitting display panel, an inorganic light emitting display panel, or a quantum dot light emitting display panel. A light emitting layer of the organic light emitting display panel may include an organic light emitting material. A light emitting layer of the inorganic light emitting display panel may include an inorganic light emitting material. A light emitting layer of the quantum dot light emitting display panel may include a quantum dot, a quantum rod, or the like.

The display panel DP may output the image IM, which is then displayed on the display surface IS.

The input sensing layer ISP may be disposed on the display panel DP to sense an external input. The input sensing layer ISP may be directly disposed on the display panel DP. According to an embodiment of the present disclosure, the input sensing layer ISP may be formed on the display panel DP through a subsequent process. In other words, when the input sensing layer ISP is directly disposed on the display panel DP, an inner adhesive film is not interposed between the input sensing layer ISP and the display panel DP. However, the inner adhesive film may be interposed between the input sensing layer ISP and the display panel DP. In this case, the input sensing layer ISP is not manufactured concurrently with the display panel DP, but is instead produced through a separate process and then affixed to an upper surface of the display panel DP by the inner adhesive film. According to an embodiment of the present disclosure, the input sensing layer ISP may be omitted.

The window WM may be formed of a transparent material capable of outputting the image IM. For example, the window WM may be formed of glass, sapphire, plastic, etc. It is illustrated that the window WM is implemented with a single layer. However, an embodiment is not limited thereto. For example, the window WM may include a plurality of layers.

The non-display area NDA of the display device DD described above may correspond to an area that is defined by printing a material with a specific color on a portion of the window WM. As an example, the window WM may include a light blocking pattern to define the non-display area NDA. The light blocking pattern, which could be a colored organic film, may be formed, for example, through a coating process.

The window WM may be coupled to the display module DM through an adhesive film. As an example, the adhesive film may include an optically clear adhesive (OCA) film. However, the adhesive film is not limited thereto. For example, the adhesive film may include a typical adhesive or sticking agent. For example, the adhesive film may include an optically clear resin (OCR) or a pressure sensitive adhesive (PSA) film.

An anti-reflection layer may be further disposed between the window WM and the display module DM. The anti-reflection layer decreases the reflectivity of external light incident from above the window WM. The anti-reflection layer according to an embodiment of the present disclosure may include a phase retarder and a polarizer. The phase retarder may be either a film type or a liquid crystal coating type and may include a λ/2 phase retarder and/or a λ/4 phase retarder. The polarizer may also be either a film type or a liquid crystal coating type. The film type may include a stretch-type synthetic resin film, and the liquid crystal coating type may include liquid crystals arranged in a specific direction. The phase retarder and the polarizer may be implemented with a single polarization film.

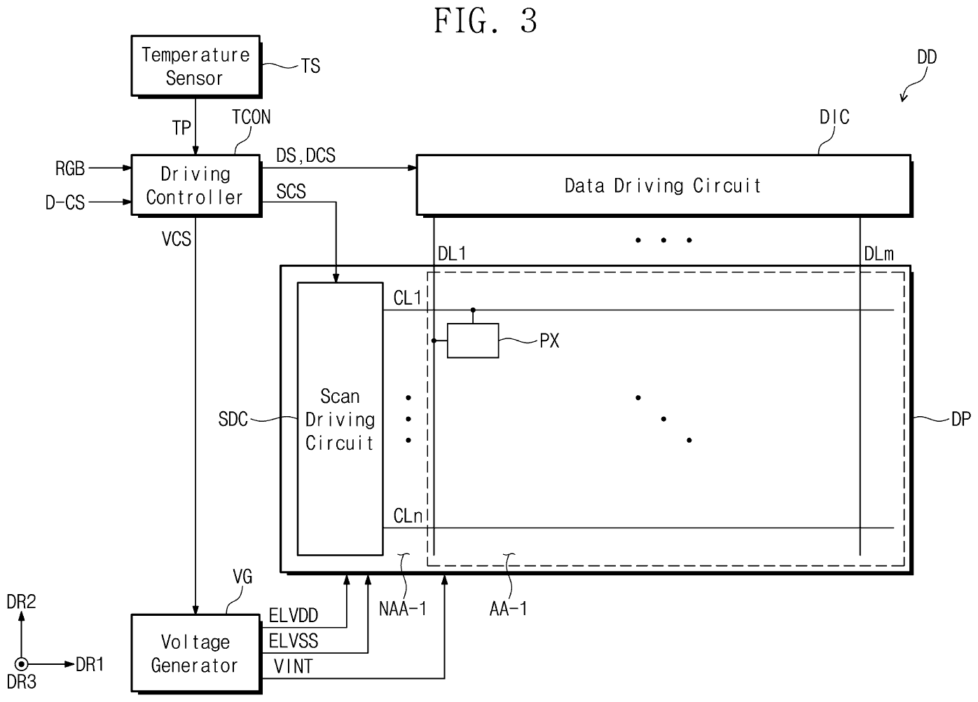

As an example of the present disclosure, the anti-reflection layer may also include color filters. The arrangement of the color filters may be determined based on the colors of light emitted by a plurality of pixels PX (see FIG. 3) included in the display panel DP. In this case, the anti-reflection layer may further include a light blocking pattern disposed between the color filters.

The display module DM may display the image IM based on an electrical signal and may transmit/receive information regarding external inputs. The display module DM can be divided into an active area AA and an inactive area NAA. The active area AA may be an area where the image IM is output from the display panel DP and displayed. Additionally, the active area AA may be an area where the input sensing layer ISP senses an external input applied from the outside. According to an embodiment, the active area AA of the display module DM may correspond to (or overlap) at least part of the display area DA.

The inactive area NAA is adjacent to the active area AA. The inactive area NAA may be an area where the image IM is not substantially displayed. For example, the inactive area NAA may surround the active area AA. However, this is just an example. The inactive area NAA can have various shapes and is not limited to a specific embodiment. According to an embodiment, the inactive area NAA of the display module DM may correspond to, or overlap with, at least portion of the non-display area NDA.

The display device DD may further include a plurality of flexible films FF connected to the display panel DP. A data driving circuit DIC may be mounted on each of the flexible films FF. As an example of the present disclosure, a data driver 200 may include the plurality of data driving circuits DIC (see FIG. 3), and the plurality of data driving circuits DIC may be respectively mounted on the plurality of flexible films FF.

The display device DD may further include at least one circuit board PCB coupled to the plurality of flexible films FF. FIG. 2 shows that the two circuit boards PCB are provided in the display device DD, but the number of circuit boards PCB is not limited thereto. Two adjacent circuit boards among the circuit boards PCB may be electrically connected to each other by a connection film CF. Additionally, at least one of the circuit boards PCB may be electrically connected to a main board. A driving controller TCON (see FIG. 3) may be disposed on at least one of the circuit boards PCB.

FIG. 2 illustrates a structure in which the data driving circuits DIC are respectively mounted on the flexible films FF, but the present disclosure is not limited thereto. For example, the data driving circuits DIC may be directly mounted on the display panel DP. In this case, a portion of the display panel DP where the data driving circuit DIC is mounted may be bent to be positioned on the back surface of the display module DM.

The input sensing layer ISP may be electrically connected to the circuit board PCB through the flexible films FF. However, an embodiment of the present disclosure is not limited thereto. In other words, the display module DM may additionally include a separate flexible film for electrically connecting the input sensing layer ISP and the circuit board PCB.

The display device DD further includes housing EDC for accommodating the display module DM. The housing EDC may be coupled with the window WM to define the exterior appearance of the display device DD. The housing EDC may absorb external shocks and prevent foreign materials or moisture from infiltrating the display module DM, thereby protecting the components accommodated in the housing EDC. In an example of the present disclosure, the housing EDC may be formed by combining a plurality of accommodating members.

The display device DD according to an embodiment may further include an electronic module that includes various functional modules for operating the display module DM, a power supply module (e.g., a battery) to provide power for the overall operations of the display device DD, a bracket that is coupled with the display module DM and/or the housing EDC to partition an inner space of the display device DD, etc.

FIG. 3 is a block diagram showing a part of a display device, according to an embodiment of the present disclosure.

Referring to FIG. 3, the display device DD may include the display panel DP, the driving controller TCON, the data driving circuit DIC, a voltage generator VG, and a temperature sensor TS. The data driving circuit DIC of FIG. 3 may be one of the data driving circuits DIC (see FIG. 2) shown in FIG. 2.

The driving controller TCON may receive an input data RGB and a control signal D-CS from a processor. The processor may include a graphics processing unit. The control signal D-CS may include various signals. For example, the control signal D-CS may include an input vertical synchronization signal, an input horizontal synchronization signal, a main clock, and a data enable signal.

The driving controller TCON may drive the plurality of pixels PX on a frame-by-frame basis.

The driving controller TCON may generate image data DS by converting the data format of the input data RGB to meet interface specifications of the data driving circuit DIC.

The driving controller TCON may generate a scan control signal SCS and a data control signal DCS based on the control signal D_CS.

The data driving circuit DIC may output grayscale voltages to drive a plurality of data lines DL1 to DLm in response to the data control signal DCS and the image data DS from the driving controller TCON. Once implemented as an integrated circuit, the data driving circuit DIC may be directly mounted in a predetermined area of the display panel DP or mounted on a separate printed circuit board using a chip on film (COF) method, and then electrically connected to the display panel DP. However, it is not limited to these methods. For example, the data driving circuit DIC may be formed through the same process as a circuit layer in the display panel DP.

A display area AA-1 and a non-display area NAA-1 may be defined in the display panel DP. The plurality of pixels PX may be located in the display area AA-1. A scan driving circuit SDC may be located in the non-display area NAA-1. The display area AA-1 may overlap the active area AA (see FIG. 2) of the display device DD. The non-display area NAA-1 may overlap the inactive area NAA (see FIG. 2) of the display device DD.

The display panel DP may include a plurality of scan lines CL1 to CLn, the plurality of data lines DL1 to DLm, the plurality of pixels PX, and the scan driving circuit SDC. Each of the plurality of pixels PX may be connected to a corresponding data line among the plurality of data lines DL1 to DLm and may be connected to a corresponding scan line among the plurality of scan lines CL1 to CLn.

Each of the plurality of scan lines CL1 to CLn may extend parallel to the first direction DR1. The plurality of scan lines CL1 to CLn may be spaced apart from each other in the second direction DR2. Each of the plurality of data lines DL1 to DLm may extend parallel to the second direction DR2 from the data driving circuit DIC. The plurality of data lines DL1 to DLm may be spaced apart from each other in the first direction DR1.

The plurality of pixels PX may be electrically connected to the plurality of scan lines CL1 to CLn and the plurality of data lines DL1 to DLm. For example, a first row of pixels PX in may be connected to the scan line CL1. A first column of pixels PX may be connected to the data line DL1.

The scan driving circuit SDC may drive the plurality of scan lines CL1 to CLn in response to the scan control signal SCS. In an embodiment of the present disclosure, the scan driving circuit SDC may be formed using the same process as the circuit layer in the display panel DP, but is not limited to this method. For example, the scan driving circuit SDC may be implemented as an Integrated circuit (IC). The scan driving circuit SDC may be directly mounted in a predetermined area of the display panel DP or on a separate printed circuit board in a Chip-on-Film (COF) scheme, and then electrically connected to the display panel DP.

The driving controller TCON may generate a voltage control signal VCS based on the data control signal D_CS. In other words, the driving controller TCON may generate the voltage control signal VCS in response to the data control signal D_CS.

The voltage generator VG may generate voltages required for the operation of the display panel DP. In an embodiment of the present disclosure, the voltage generator VG may generate a first driving voltage ELVDD, a second driving voltage ELVSS, and an initialization voltage VINT, which are required for the operation of the display panel DP.

Each of the plurality of pixels PX receives the first driving voltage ELVDD, the second driving voltage ELVSS, and the initialization voltage VINT.

In addition to the first driving voltage ELVDD, the second driving voltage ELVSS, and the initialization voltage VINT, the voltage generator VG may further generate various other voltages (e.g., a gamma reference voltage Vref, a data driving voltage AVDD, a gate-on voltage, and a gate-off voltage), which are necessary for the operation of the data driving circuit DIC and the scan driving circuit SDC.

The temperature sensor TS may measure the temperature of the display panel DP. In an embodiment of the present disclosure, the temperature sensor TS may measure the temperature of the display panel DP by measuring the temperature of the outside air around the display panel DP. As an example, the temperature sensor TS may determine the temperature of the display panel DP by measuring the ambient air temperature surrounding the display panel DP. The temperature sensor TS may transmit a temperature signal TP including temperature information of the display panel DP to the driving controller TCON.

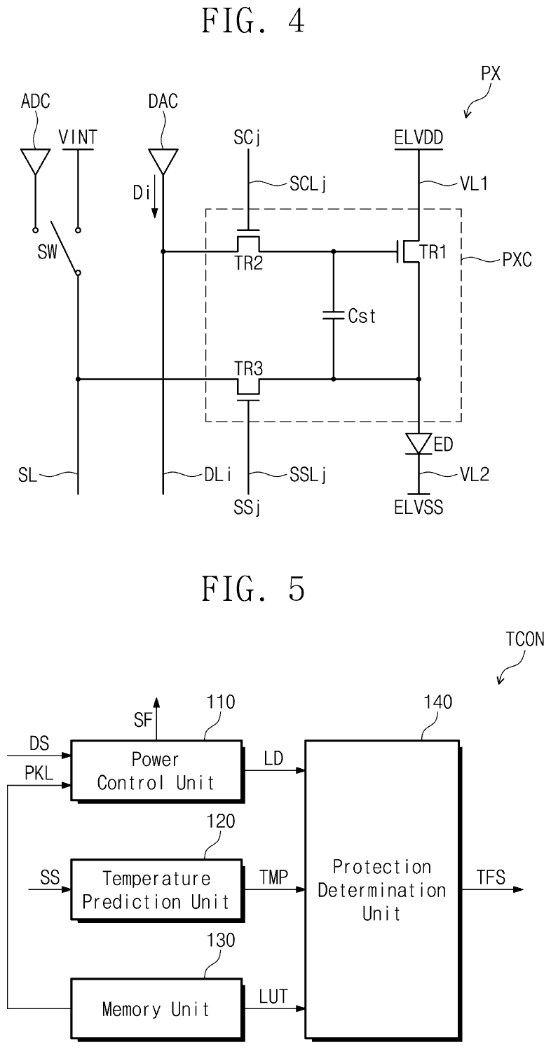

FIG. 4 is an equivalent circuit diagram of a pixel, according to an embodiment of the present disclosure.

A j-th scan line among the plurality of scan lines CL1 to CLn may include a first scan line SCLj and a second scan line SSLj. FIG. 4 illustrates an equivalent circuit diagram of the pixel PX connected to an i-th data line DLi among the plurality of data lines DL1 to DLm, the first scan line SCLj and the second scan line SSLj, which are illustrated in FIG. 3.

Each of the plurality of pixels PX (see FIG. 3) shown in FIG. 3 may have the same circuit configuration as the pixel PX (see FIG. 4) shown in FIG. 4.

Referring to FIGS. 3 and 4, the pixel PX may include at least one light emitting element ED and a pixel circuit PXC. The pixel circuit PXC may be electrically connected to the light emitting element ED and may provide a current that corresponds to a data signal Di delivered from the data line DLi to the light emitting element ED. The pixel circuit PXC may include a first transistor TR1, a second transistor TR2, a third transistor TR3, and a capacitor Cst.

Each of the first to third transistors TR1 to TR3 may be an N-type transistor by using an oxide semiconductor as a semiconductor layer. However, the present disclosure is not limited thereto. In an embodiment, each of the first to third transistors TR1 to TR3 may be a P-type transistor having a low-temperature polycrystalline silicon (LTPS) semiconductor layer. In an embodiment, at least one of the first to third transistors TR1 to TR3 may be an N-type transistor and the others thereof may be P-type transistors. Moreover, a circuit configuration of the pixel circuit PXC according to an embodiment of the present disclosure is not limited to the embodiment of FIG. 4. The pixel circuit PXC illustrated in FIG. 4 is only an example. For example, the configuration of the pixel circuit PXC may be variously modified and implemented.

The first scan line SCLj may deliver a first scan signal SCj, and the second scan line SSLj may deliver a second scan signal SSj. The data line DLi transfers the data signal Di. The data signal Di may have a voltage level corresponding to the image data DS.

A first voltage line VL1 may deliver the first driving voltage ELVDD to the pixel circuit PXC. A second voltage line VL2 may deliver the second driving voltage ELVSS to the cathode (or a second electrode) of the light emitting element ED.

The first transistor TR1 may include a first electrode connected to the first voltage line VL1, a second electrode electrically connected to an anode (or a first electrode) of the light emitting element ED, and a gate electrode connected to a first end of the capacitor Cst. The first transistor TR1 may supply a driving current to the light emitting element ED in response to the data signal Di delivered through the data line DLi according to a switching operation of the second transistor TR2. The first transistor TR1 may be referred to as the “driving transistor TR1”.

The second transistor TR2 may include a first electrode connected to the data line DLi, a second electrode connected to the gate electrode of the first transistor TR1, and a gate electrode connected to the first scan line SCLj. The second transistor TR2 may be turned on in response to the first scan signal SCj received through the first scan line SCLj, allowing the data signal Di from the data line DLi to be transmitted to the gate electrode of the first transistor TR1.

The data line DLi may be electrically connected to a digital-to-analog converter (DAC) of the data driving circuit DIC (see FIG. 3).

The third transistor TR3 may include a first electrode connected to a sensing line SL, a second electrode connected to the anode of the light emitting element ED, and a gate electrode connected to the second scan line SSLj. The third transistor TR3 may be turned on in response to a second scan signal SSj received through the second scan signal SSLj and subsequently deliver the initialization voltage VINT to the anode of the light emitting element ED.

The driving controller TCON may be connected to the sensing line SL. The driving controller TCON may detect a sensing current flowing through the sensing line SL in units of sensing frames.

The driving controller TCON may compare the sensed sensing current and a predetermined reference current and may generate a signal based on the comparison result. The driving controller TCON may generate the voltage control signal VCS to control a voltage level of the first driving voltage ELVDD produced by the voltage generator VG based on the signal reflecting the comparison result.

The first end of the capacitor Cst is connected to the gate electrode of the first transistor TR1, as described above, and a second end of the capacitor Cst is connected to the second electrode of the first transistor TR1. The structure of the pixel PX according to an embodiment is not limited to the structure illustrated in FIG. 5. For example, the number of transistors included in the one pixel PX, the number of capacitors included in the pixel PX, and the connection relationship between the transistors and the capacitors may be variously modified.

A switch SW may electrically connect the sensing line SL to the input terminal of the initialization voltage VINT or an analog to digital converter (ADC) of the data driving circuit DIC in response to a control signal.

FIG. 5 is a block diagram showing a driving controller, according to an embodiment of the present disclosure.

Referring to FIGS. 3 and 5, the driving controller TCON may include a power control unit 110, a temperature prediction unit 120, a memory unit 130, and a protection determination unit 140. Each of the power control unit 110, the temperature prediction unit 120, the memory unit 130, and the protection determination unit 140 may be implemented in hardware as an electronic circuit.

The power control unit 110 may receive the image data DS and peak luminance PKL. The power control unit 110 may output a load LD of a block of the display panel DP based on the image data DS. The power control unit 110 may output a scale factor SF based on the load LD. This will be described later. The power control unit 110 may identify a luminance value determined for each load LD based on the scale factor SF and the peak luminance PKL.

The temperature prediction unit 120 may calculate a temperature value TMP of the display panel DP.

The temperature prediction unit 120 may receive a sensing signal SS converted from the sensing current received through the sensing line SL (see FIG. 4). The sensing signal SS may include a threshold voltage (referred to as “Vth”) of the first transistor TR1 (see FIG. 4). The threshold voltage of the first transistor TR1 (see FIG. 4) can vary with temperature. The temperature prediction unit 120 may calculate the temperature value TMP based on the sensing signal SS. In other words, the temperature prediction unit 120 may calculate the temperature value TMP based on the threshold voltage of the driving transistor TR1 (see FIG. 4).

The memory unit 130 may store the peak luminance PKL of the display panel DP and a load-specific temperature lookup table LUT.

The display device DD may be manufactured through predetermined processes, which may include a cell process and a module process.

The cell process involves cutting a manufactured thin-film-transistor (TFT) substrate into individual parts based on their intended use. In other words, each cell, which is a portion cut from the substrate, may be further processed to form the display panel DP.

The module process involves attaching various components to a panel that has undergone the cell process, thereby transforming these attached components into a module suitable for use as a component. The components may include the data driving circuit DIC and the voltage generator VG.

The module process may include a correction step for correcting gray-specific luminance. During this correction process, the peak luminance PKL of the display panel DP may be measured. In the case, the measured peak luminance PKL may be stored in the memory unit 130. However, this is just an example. For example, the peak luminance PKL and the load-specific temperature lookup table LUT according to an embodiment of the present disclosure may be stored in separate memories. For example, the peak luminance PKL may be stored in a first memory, and the load-specific temperature lookup table LUT may be stored in a second memory. In this case, the first memory may be an embedded multimedia card (eMMC).

The protection determination unit 140 may receive the load LD, the load-specific temperature lookup table LUT, and the temperature value TMP. When the temperature value TMP exceeds a threshold value for a predetermined time, the protection determination unit 140 may output a temperature protection flag signal TFS to block the operation of the voltage generator VG.

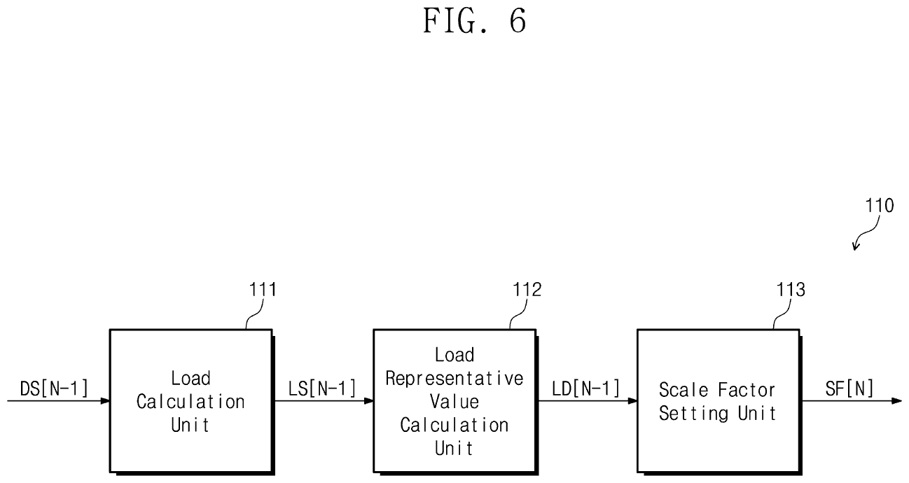

FIG. 6 is a block diagram of a power control unit, according to an embodiment of the present disclosure.

The plurality of pixels PX (see FIG. 3) may be driven in units of a frame. In other words, the plurality of pixels PX (see FIG. 3) may be driven on a per-frame basis. Image data of an (N−1)-th frame among the image data DS (see FIG. 4) may be referred to as an “(N−1)-th image data DS[N−1]”. The load of the (N−1)-th frame among the load LD (see FIG. 4) may be referred to as an “(N−1)-th load LD[N−1]”.

Referring to FIGS. 5 and 6, the power control unit 110 may include a load calculation unit 111, a load representative value calculation unit 112, and a scale factor setting unit 113. Each of these components may be implemented in hardware as an electronic circuit.

The load calculation unit 111 may calculate the sum LS[N−1] of all grayscales of the (N−1)-th image data DS[N−1] based on the (N−1)-th image data DS[N−1]. For example, the display panel DP (see FIG. 3) may be divided into a plurality of blocks. The load calculation unit 111 may calculate the sum of the grayscales for each block. Specifically, the load calculation unit 111 may calculate the sum LS[N−1] of all grayscales (e.g., grayscale values) for the (N−1)-th image data DS[N−1] by summing the grayscales of each block. Here, ‘N’ may be a natural number of 2 or more.

The load representative value calculation unit 112 may calculate the load LD[N−1] of the (N−1)-th image data DS[N−1] based on the sum LS[N−1] of all grayscales of the (N−1)-th image data DS[N−1]. The load LD[N−1] may have a value between 0% and 100%. The plurality of light emitting elements ED (see FIG. 4) may function as a load to drive the display panel DP (see FIG. 3). The load increases as the number of driven light emitting elements ED (see FIG. 4) increases. For example, when the (N−1)-th image data DS[N−1] represents a fully black image (e.g., 0 grayscale), the load LD[N−1] may be 0%. Conversely, when the (N−1)-th image data DS[N−1] represents a fully white image (e.g., 255 grayscale), the load LD[N−1] may be 100%.

The load representative value calculation unit 112 may output the load LD[N−1] to the protection determination unit 140.

The scale factor setting unit 113 may generate a scale factor SF[N] to adjust the grayscale of the image data DS based on the load LD[N−1] of the (N−1)-th image data DS[N−1]. To maintain or decrease the grayscale of the (N−1)-th image data DS[N−1], the scale factor SF[N] may have a value smaller than or equal to 1. For example, when the scale factor SF[N] is 0.5, the grayscale of the (N−1)-th image data DS[N−1] may be reduced by half.

As the display area operating in a white mode increases, the number of light emitting elements ED (see FIG. 4) that are driven may also increase. In this case, as the load LD[N−1] increases, more power may be consumed. However, according to an embodiment of the present disclosure, the driving current supplied to the light emitting elements ED (see FIG. 4) may be limited, and the display panel DP (see FIG. 3) may be driven by reducing the luminance of the area (or areas) displayed in the white mode based on the scale factor SF[N] as the load LD[N−1] increases. Consequently, this approach can provide the display device DD (see FIG. 1) with reduced power consumption.

As illustrated in FIG. 5, one frame may be delayed such that the power control unit 110 generates the scale factor SF[N]. In other words, the scale factor SF[N] generated based on the (N−1)-th image data DS[N−1] may be applied to the N-th image data (DS[N]).

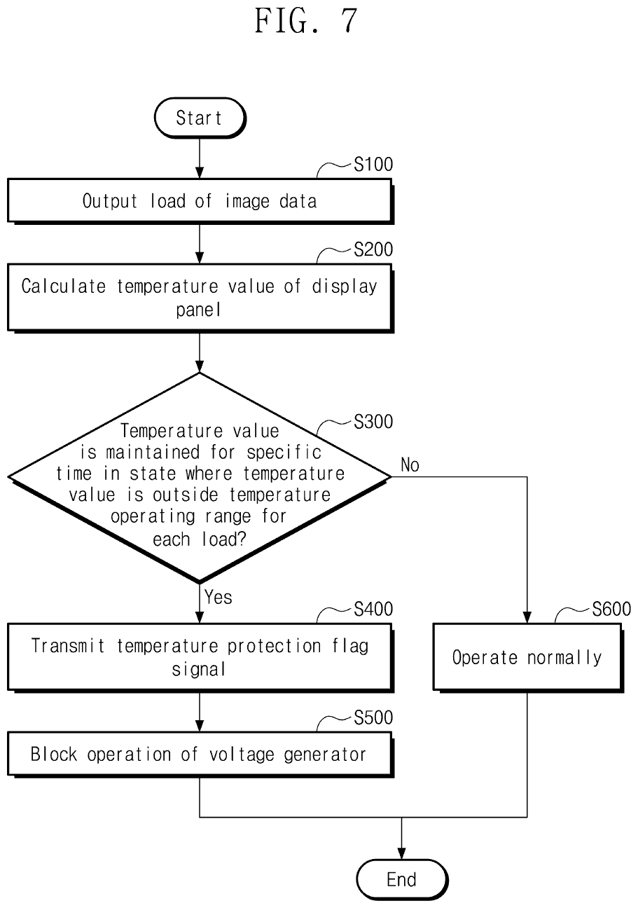

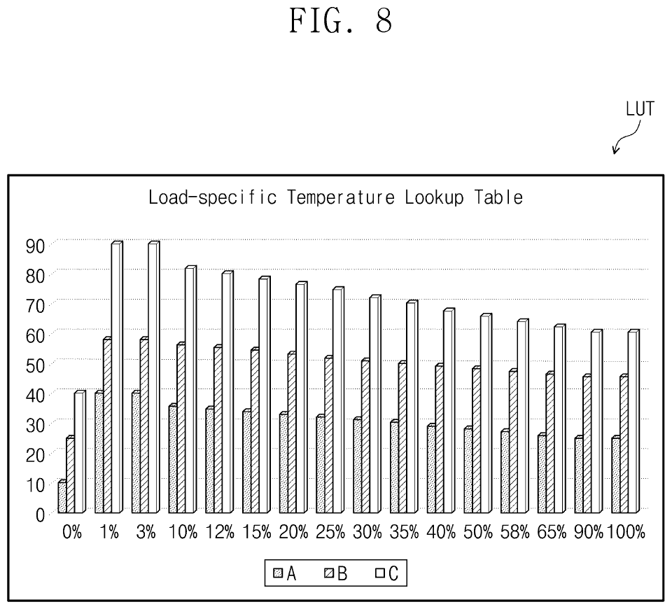

FIG. 7 is a flowchart illustrating a method of driving a display device, according to an embodiment of the present disclosure. FIG. 8 shows a load-specific temperature lookup table, according to an embodiment of the present disclosure.

Referring to FIGS. 5, 7, and 8, the power control unit 110 may output the load LD of the image data DS (S100).

The temperature prediction unit 120 may calculate the temperature value TMP of the display panel DP (S200).

The temperature value TMP may include an average temperature value and a peak temperature value. The average temperature value is the average of the temperature values calculated by the temperature prediction unit 120. The peak temperature value is the maximum value of the temperature values calculated by the temperature prediction unit 120.

The protection determination unit 140 may receive the load LD, the temperature value TMP, and the load-specific temperature lookup table LUT.

The horizontal axis of the load-specific temperature lookup table LUT shows the load LD in percentage (%) units, and the vertical axis of the load-specific temperature lookup table LUT shows temperature in degrees Celsius.

A minimum temperature ‘A’, an average temperature ‘B’, and a maximum temperature ‘C’ of the display panel DP for each load LD may be stored in the load-specific temperature lookup table LUT.

The minimum temperature ‘A’, the average temperature ‘B’, and the maximum temperature ‘C’ may each be measured based on the cell with the lowest efficiency and subsequently stored in the memory unit 130. As a result, regardless of the efficiency of the display panel DP, the protection determination unit 140 may easily detect an abnormal temperature state using the load-specific temperature lookup table LUT.

The minimum temperature ‘A’ may be set based on the temperature at which the luminance of the display panel DP decreases at the corresponding load LD.

The average temperature ‘B’ may be set based on the temperature of the display panel DP during a normal operation. In other words, the average temperature ‘B) may be set based on the typical operating temperature of the display panel DP during normal conditions.

The maximum temperature ‘C’ may be set based on the temperature when the load LD is maintained in a white box condition, or may be set based on the minimum temperature at which a power supply line becomes burnt and damaged due to overcurrent.

The protection determination unit 140 may determine whether the temperature value TMP is maintained for a specific time in a state where the temperature value TMP is outside a temperature operating range for each load LD (S300). In other words, the protection determination unit 140 may determine whether the temperature value TMP remains outside the operating temperature range for a specific duration for each load LD.

The protection determination unit 140 may determine whether the temperature value TMP exceeds a threshold value for a predetermined time. The threshold value may be at least one of the minimum temperature ‘A’, the average temperature ‘B’, and the maximum temperature ‘C’ of the load-specific temperature lookup table LUT. In other words, the threshold value may have a different value for each load LD. For example, a threshold value applied when the load LD is 10% may be different from a threshold value applied when the load LD is 90%.

The threshold value may be the maximum temperature ‘C’. The protection determination unit 140 may compare a peak temperature value with the maximum temperature ‘C’.

The threshold value may also be the average temperature ‘B’. The protection determination unit 140 may further compare an average temperature value with the average temperature ‘B’.

The protection determination unit 140 may calculate the minimum temperature ‘A’, the average temperature ‘B’, and the maximum temperature ‘C’ for loads LD, which are not listed in the load-specific temperature lookup table LUT, using an interpolation method.

The protection determination unit 140 may define the criterion for determining the predetermined time as a count value obtained by counting the number of frames. If this count value exceeds a predetermined value, the protection determination unit 140 may determine that the predetermined time has been surpassed.

If the temperature value TMP exceeds the threshold value for a predetermined time based on the load LD, the load-specific temperature lookup table LUT, and the temperature value TMP, the protection determination unit 140 may generate the temperature protection flag signal TFS.

The protection determination unit 140 may transmit the temperature protection flag signal TFS to the voltage generator VG (S400).

The protection determination unit 140 may block the operation of the voltage generator VG based on the temperature protection flag signal TFS (S500).

For example, if the load LD of the image data DS calculated by the power control unit 110 is 10%, and the peak temperature, which is the temperature value TMP calculated by the temperature prediction unit 120, exceeds 82 degrees, the protection determination unit 140 may determine that the peak temperature exceeds the threshold value, based on the load-specific temperature lookup table LUT. In this scenario, if the peak temperature continues to exceed the threshold for tens of frames, the protection determination unit 140 may generate the temperature protection flag signal TFS, by determining that the temperature value TMP has remained outside the operating temperature range for a specific duration for each load. Consequently, the protection determination unit 140 may block the operation of the voltage generator VG based on the temperature protection flag signal TFS.

Unlike an embodiment of the present disclosure, when a short circuit occurs in a line between the voltage generator VG and the display panel DP due to external shocks during the manufacturing process of the display device DD, a progressive burn may occur because the current becomes concentrated on the short-circuited line. Additionally, some layers attached to the rear surface of the display panel DP may lift due to the decrease in adhesive strength, which is caused by the temperature rise from the burn. Moreover, if the connection film CF is incorrectly fastened, the first driving voltage ELVDD from the voltage generator VG may be delivered to one side, leading to current concentration, which can cause the pad part to burn and become damaged due to heat generation. However, according to an embodiment of the present disclosure, the protection determination unit 140 may detect the temperature of the display panel DP for each frame and block the operation of the voltage generator VG if the temperature remains outside the operating range for each load for a specific time. This approach prevents the lines from burning and becoming damaged, thereby enhancing the stability of the display panel DP. Accordingly, the display device DD with improved reliability may be provided.

When the temperature value TMP is smaller than the threshold value or does not exceed the threshold value for a predetermined time based on the load LD, the load-specific temperature lookup table LUT, and the temperature value TMP, the protection determination unit 140 may determine that the operation is normal, and therefore, take no further action (S600).

The protection determination unit 140 may receive the temperature signal TP from the temperature sensor TS. The protection determination unit 140 may compare temperature information of the temperature signal TP measured by the temperature sensor TS with the temperature value TMP calculated by the temperature prediction unit 120.

When the temperature information is different from the temperature value TMP, the protection determination unit 140 may generate a signal to indicate a malfunction in the temperature prediction unit 120.

According to an embodiment of the present disclosure, the reliability of the temperature prediction unit 120 may be secured based on the temperature information measured by the temperature sensor TS. Users can verify the reliability of the progressive burn operation, according to an embodiment of the present disclosure, based on the signal indicating the malfunction. Accordingly, the display device DD with improved reliability may be provided.

As described above, a protection determination unit may detect the temperature of the display panel for each frame and block the operation of a voltage generator when the temperature remains outside an operating range for each load for a specific time. This approach prevents the lines from being burnt and damaged, thereby ensuring the stability of a display panel. Therefore, it is possible to provide a display device with improved reliability and a method of driving the display device.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a display panel including a plurality of pixels;
a voltage generator configured to provide a driving voltage to the plurality of pixels; and
a driving controller configured to receive an image signal and drive the plurality of pixels in frame units,
wherein the driving controller includes:
a power control circuit configured to receive image data generated based on the image signal and output a load of the image data;
a temperature prediction circuit configured to calculate a temperature value of the display panel;
a memory configured to store a load-specific temperature lookup table; and
a protection determination circuit configured to block an operation of the voltage generator when the temperature value exceeds a threshold value for a predetermined time, based on the load, the load-specific temperature lookup table, and the temperature value.

2. The display device of claim 1, wherein the predetermined time is a count value obtained by counting a number of the frames, and
when the count value exceeds a predetermined value, the protection determination circuit determines that the predetermined time has been exceeded.

3. The display device of claim 1, wherein when the temperature value exceeds the threshold value for the predetermined time, the protection determination circuit generates a temperature protection flag signal.

4. The display device of claim 3, wherein the protection determination circuit transmits the temperature protection flag signal to the voltage generator.

5. The display device of claim 1, wherein the power control circuit includes:
a load calculation circuit configured to calculate a sum of all grayscales of the image data based on the image data;
a load representative value calculation circuit configured to calculate the load of the image data based on the sum; and
a scale factor setting circuit configured to generate a scale factor to change a grayscale of the image data based on the load.

6. The display device of claim 1, wherein each of the plurality of pixels includes a pixel circuit and a light emitting element,
wherein the pixel circuit includes a driving transistor, and
wherein the temperature prediction circuit calculates the temperature value based on a threshold voltage of the driving transistor.

7. The display device of claim 1, wherein the temperature value of the display panel includes an average temperature value and a peak temperature value.

8. The display device of claim 7, wherein a minimum temperature, an average temperature, and a maximum temperature of the display panel for respective loads are stored in the load-specific temperature lookup table, and
wherein the minimum temperature, the average temperature, or the maximum temperature is the threshold value.

9. The display device of claim 8, wherein the protection determination circuit compares the peak temperature value with the maximum temperature in the load-specific temperature lookup table.

10. The display device of claim 9, wherein the protection determination circuit further compares the average temperature value of the display panel with the average temperature in the load-specific temperature lookup table.

11. The display device of claim 8, wherein the protection determination circuit calculates the minimum temperature, the average temperature, and the maximum temperature for the load, which are not included in the load-specific temperature lookup table, using an interpolation method.

12. The display device of claim 1, further comprising:
a temperature sensor configured to measure temperature information of the display panel.

13. The display device of claim 12, wherein when the temperature information is different from the temperature value, the protection determination circuit generates a signal that indicates a malfunction of the temperature prediction circuit.

14. A method for driving a display device including a display panel including a plurality of pixels, a voltage generator for providing a driving voltage to the plurality of pixels, and a driving controller for driving the plurality of pixels in units of a frame, the method comprising:
outputting a load for image data generated based on an image signal;
calculating a temperature value of the display panel; and
blocking an operation of the voltage generator when the temperature value exceeds a threshold value for a predetermined time, based on the load, a load-specific temperature lookup table, and the temperature value.

15. The method of claim 14, wherein the predetermined time is a count value obtained by counting a number of the frames, and
when the count value exceeds a predetermined value, the predetermined time has been exceeded.

16. The method of claim 15, wherein the blocking of the operation of the voltage generator includes:
when the temperature value exceeds the threshold value for the predetermined time, generating a temperature protection flag signal, and
transmitting the temperature protection flag signal to the voltage generator.

17. The method of claim 14, wherein each of the plurality of pixels includes a pixel circuit and a light emitting element,
wherein the pixel circuit includes a driving transistor, and
wherein the calculating of the temperature value includes:
calculating the temperature value based on a threshold voltage of the driving transistor.

18. The method of claim 14, wherein the temperature value includes an average temperature value and a peak temperature value,
wherein a minimum temperature, an average temperature, and a maximum temperature of the display panel for a respective load are stored in the load-specific temperature lookup table, and
wherein the blocking of the operation of the voltage generator includes:
comparing the peak temperature value with the maximum temperature in the load-specific temperature lookup table.

19. The method of claim 18, wherein the blocking of the operation of the voltage generator further includes:
comparing the average temperature value with the average temperature in the load-specific temperature lookup table.

20. The method of claim 14, wherein a temperature of the load-specific temperature lookup table is the threshold value, and
wherein the blocking of the operation of the voltage generator includes:
calculating the temperature for the load, which is not included in the load-specific temperature lookup table, using an interpolation method.

21. A display device comprising:
a display panel including a plurality of pixels;
a voltage generator configured to provide a driving voltage to the plurality of pixels; and
a driving controller configured to receive an image signal and drive the plurality of pixels in frame units,
wherein the driving controller includes:
a power control circuit configured to determine a load associated with image data in the image signal;
a temperature prediction circuit configured to calculate a temperature of the display panel;
a memory configured to store temperature data for different loads; and
a protection determination circuit configured to stop an operation of the voltage generator when the temperature exceeds a predetermined threshold for a predetermined time, based on the load and the stored temperature data.
